(19) United States
(12) Patent Application Publication
(10) Pub. No.: US 2024/0324810 A1
(43) Pub. Date: Oct. 3, 2024

(54) DRIP COFFEE MAKER WITH TRANSFORMABLE FILTER SUPPORT

(71) Applicant: Midea Group Co., Ltd., Shunde (CN)

(72) Inventors: Simon Fowler, Louisville, KY (US); Daniel J. Trice, Louisville, KY (US)

(21) Appl. No.: 18/192,073

(22) Filed: Mar. 29, 2023

(51) Int. Cl. A47J 31/06; A47J 31/10

(52) U.S. Cl. CPC A47J 31/0647; A47J 31/10

(57) ABSTRACT

A drip coffee maker includes a transformable filter support that is capable of transforming into a plurality of configurations to support different sizes and/or profiles of coffee filters and/or to support different types of coffee brewing operations. In some instances, for example, a transformable filter support may be configured to include one configuration suitable for supporting a narrow-profile cone filter when brewing a single cup and/or lower volume of coffee, as well as another configuration suitable for supporting a wide-profile basket filter when brewing a full pot and/or greater volume of coffee.

### BACKGROUND

Coffee is a beverage made from roasted coffee beans, and has long been one of the most popular drinks in the world. Numerous devices and processes for making coffee have been developed, with most incorporating some variation on bringing water into contact with ground coffee beans to extract water soluble components from the ground coffee beans that give coffee its distinctive taste. However, roasted coffee beans can have numerous soluble components that impart different types of flavors that can be pleasing or displeasing to different palates, so variations in brewing processes can significantly impact the flavor of the resulting coffee.

Two primary types of coffee brewing devices in common use today are generally referred to as espresso machines and drip coffee makers. Espresso machines force hot pressurized water relatively quickly through packed and finely ground coffee beans to generate a highly concentrated, but low volume type of coffee generally referred to as espresso. Drip coffee makers, on the other hand, rely primarily on gravity rather than pressure, and drip heated water onto a brew basket of more coarsely ground coffee beans to allow the water to seep through the coffee grounds to extract the flavor-producing components therefrom. Drip coffee makers also generally incorporate a disposable or reusable filter in the brew basket such that the coffee grounds are retained in the brew basket while the coffee is fed by gravity into a cup or larger container disposed below the brew basket.

Particularly with drip coffee makers, a number of factors can greatly impact a coffee flavor profile, including, for example, the amounts of ground coffee and water that are used, the grind size used to grind the coffee beans, the temperature of the water, and the amount of time the water contacts the ground coffee, among others. Control over water/coffee contact time in a brew basket, for example, is generally based on the rate in which hot water enters the brew basket and the rate in which coffee exits the brew basket. Basic drip coffee makers may control these variables simply through the design of the water supply that supplies heated water to the brew basket and the outlet through which coffee exits the brew basket; however, such designs offer only a single water/coffee contact time that may not be optimal for all types or quantities of coffee, grind sizes, etc.

Moreover, the brew baskets used in many drip coffee makers support only a single size and shape of filter that is optimized for the typical volumes of coffee to which such drip coffee makers are designed to be used. Some drip coffee makers, for example, are designed to brew full pots or carafes of coffee, and rely on relatively wide-profile filters, commonly referred to as basket filters, that have relatively wide and flat bottoms that enable the larger quantities of ground coffee needed for full pots or carafes of coffee to spread out across the width of the filters and provide suitable flow resistance for ensuring a desirable water/coffee contact time during the brewing process. Other drip coffee makers are designed to brew smaller volumes of coffee, e.g., single cups, and rely on relatively narrow-profile filters, commonly referred to as cone filters, that keep the relatively smaller quantities of ground coffee from spreading out too much and allowing water to pass too quickly through the filters.

While some drip coffee makers are advertised as supporting wider ranges of brewing volumes, these devices tend to produce inconsistent results for different brewing volumes. When a basket filter is used for brewing single cups, for example, the smaller quantity of ground coffee needed for a suitable brewing ratio results in a thin layer of ground coffee across the bottom of the filter that provides insufficient flow resistance, leading to insufficient water/coffee contact time and underextracted coffee. Conversely, when a cone filter is used for brewing full pots of coffee, the larger quantity of ground coffee needed for a suitable brewing ratio may produce excessive flow resistance and overextraction in some instances, and in other instances, may even cause the filter to overflow during brewing.

Attempts have been made to address this problem by using inserts or by supplying multiple baskets for different brewing volumes. However, the use of multiple components can lead to consumer confusion, and brewing using the wrong insert or basket for a particular brewing volume. In addition, in such situations a consumer is required to either find an appropriate storage location for any extra components and then remember to retrieve those components when needed, or otherwise increase the amount of clutter on their countertop by keeping the extra components out and near the drip coffee maker.

Therefore, a significant need continues to exist in the art for a manner of providing greater brewing consistency in a drip coffee maker over a wider range of brewing volumes.

### SUMMARY

The herein-described embodiments address these and other problems associated with the art by utilizing in a drip coffee maker a transformable filter support that is capable of transforming into a plurality of configurations to support different sizes and/or configurations of coffee filters and/or to support different types of coffee brewing operations. In some instances, for example, a transformable filter support may be configured to include one configuration suitable for supporting a narrow-profile cone filter when brewing a single cup and/or lower volume of coffee, as well as another configuration suitable for supporting a wide-profile basket filter when brewing a full pot and/or greater volume of coffee.

Therefore, consistent with one aspect of the invention, a drip coffee maker may include a brew basket configured to house coffee grounds during brewing, the brew basket including an outlet proximate a bottom thereof through which coffee is dispensed, a water dispenser disposed upstream of the brew basket and configured to supply heated water to the brew basket to bring the heated water into contact with the coffee grounds to perform a drip coffee brewing operation, and a transformable filter support disposed in the brew basket to support a filter, the transformable filter support configured to transform between a plurality of different configurations for use with different coffee brewing operations.

Moreover, in some embodiments, the plurality of different configurations different from one another based on cross-sectional profile. Further, in some embodiments, the plurality of different configurations different from one another based on brewing operation type. Also, in some embodiments, the plurality of different configurations different from one another based on brewing volume. Further, in some embodiments, the plurality of different configurations different from one another based on size and/or shape of filter supported by the transformable filter support. In some embodiments, the plurality of different configurations include a first configuration configured to support a narrow-profile cone filter and a second configuration configured to support a wide-profile basket filter.

Also, in some embodiments, the transformable filter support includes a frame, the frame including a top member, a bottom member, and a plurality of hinged legs, each hinged leg secured to and extending between the top and bottom members and including inwardly-facing surfaces configured to support the filter in the transformable filter support. In some embodiments, each hinged leg includes first and second leg segments rotatably coupled to one another through a hinge, the first leg segment rotatably coupled to the top member and the second leg segment rotatably coupled to the bottom member. Further, in some embodiments, each hinged leg further includes a longitudinal slot, and the transformable filter support further includes an alignment ring extending through the longitudinal a lot of each hinged leg to align the plurality of legs with one another. In some embodiments, the top member includes a top ring and the bottom member includes a bottom ring, and the first leg segment of each leg is rotatably coupled to the top ring and the second leg segment of each leg is rotatably coupled to the bottom ring.

Further, in some embodiments, the transformable filter support further includes a liner supported within the frame and including a flexible sidewall and an outlet configured to convey brewed coffee to the outlet of the brew basket. Also, in some embodiments, the liner is secured to each of the plurality of hinged legs. In addition, in some embodiments, the liner is formed from an elastic material and is biased to a first configuration of the plurality of different configurations when in an undisturbed state such that transformation of the transformable filter support to a second configuration of the plurality of different configurations deforms and loads the liner. In some embodiments, the first configuration is an extended configuration and the second configuration is a compressed configuration, and when in the extended configuration the top member is further away from the bottom member than when in the compressed configuration.

In addition, in some embodiments, the brew basket includes a plurality of inwardly-projecting vertical columns and the top member includes a plurality of slots configured to receive the plurality of inwardly-projecting vertical columns when the transformable filter support is transforming between the first and second configurations, and at least a portion of the top member is rotatable about a substantially vertical axis when the transformable filter support is in the second configuration to move the plurality of slots out of alignment with the plurality of inwardly-projecting vertical columns and thereby maintain the transformable filter support in the second configuration. Also, in some embodiments, each of the plurality of inwardly-projecting vertical columns includes an intermediate slot configured to maintain the transformable filter support in a third configuration that is intermediate the first and second configurations.

In addition, in some embodiments, the plurality of different configurations includes first and second configurations, the transformable filter support is biased to the first configuration, and the transformable filter support further includes a hook and release mechanism configured to releasably hold the transformable filter support in the second configuration. In some embodiments, the plurality of different configurations includes first and second configurations, the transformable filter support is biased to the first configuration, and the transformable filter support further includes a press release loop mechanism configured to toggle the transformable filter support between the first and second configurations when pressed. Further, in some embodiments, the plurality of different configurations includes first and second configurations, and the transformable filter support further includes an automatic lift mechanism including an electronically-controlled drive configured to move the transformable filter support between the first and second configurations.

Consistent with another aspect of the invention, a transformable filter support for use in a brew basket of a drip coffee maker may include a frame configured to be received in the brew basket, the frame including a top member, a bottom member, and a plurality of hinged legs, each hinged leg secured to and extending between the top and bottom members and including inwardly-facing surfaces configured to support the filter in the transformable filter support, and a liner supported within the frame and including a flexible sidewall and an outlet configured to convey brewed coffee to an outlet of a brew basket, where the top and bottom members are movable relative to one another to transform the transformable filter support between a plurality of different configurations for use with different coffee brewing operations.

Other embodiments may include various methods for making and/or using any of the aforementioned constructions.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a front elevational view of a drip coffee maker consistent with some embodiments of the invention.

FIG. 2 is a block diagram of an example control system for the drip coffee maker of FIG. 1.

FIG. 3 is a top perspective view of a brew basket including a transformable filter support and suitable for use in the drip coffee maker of FIG. 1, and with the transformable filter support configured in a small brewing volume configuration.

FIG. 4 is a top perspective view of the brew basket of FIG. 3, with the transformable filter support configured in a large brewing volume configuration.

FIG. 5 is an exploded perspective view of the transformable filter support of FIG. 3, and configured in the small brewing volume configuration.

FIG. 6 is an exploded perspective view of the transformable filter support of FIG. 4, and configured in the large brewing volume configuration.

FIG. 7 is a cross-sectional view of the brew basket and transformable filter support of FIG. 3, and taken through lines 7-7 thereof.

FIG. 8 is a cross-sectional view of the brew basket and transformable filter support of FIG. 4, and taken through lines 8-8 thereof.

FIG. 9 is a cross-sectional view of another brew basket and transformable filter support consistent with some embodiments of the invention, and including a hook and release mechanism.

FIG. 10 is a functional view of another brew basket and transformable filter support consistent with some embodiments of the invention, and including a press release loop mechanism.

FIG. 11 is a functional view of yet another brew basket and transformable filter support consistent with some embodiments of the invention, and including an automatic lift mechanism.

### DETAILED DESCRIPTION

The embodiments described hereinafter are directed in part to a transformable filter support that is capable of transforming into a plurality of configurations to support different sizes and/or configurations of coffee filters and/or to support different types of coffee brewing operations.

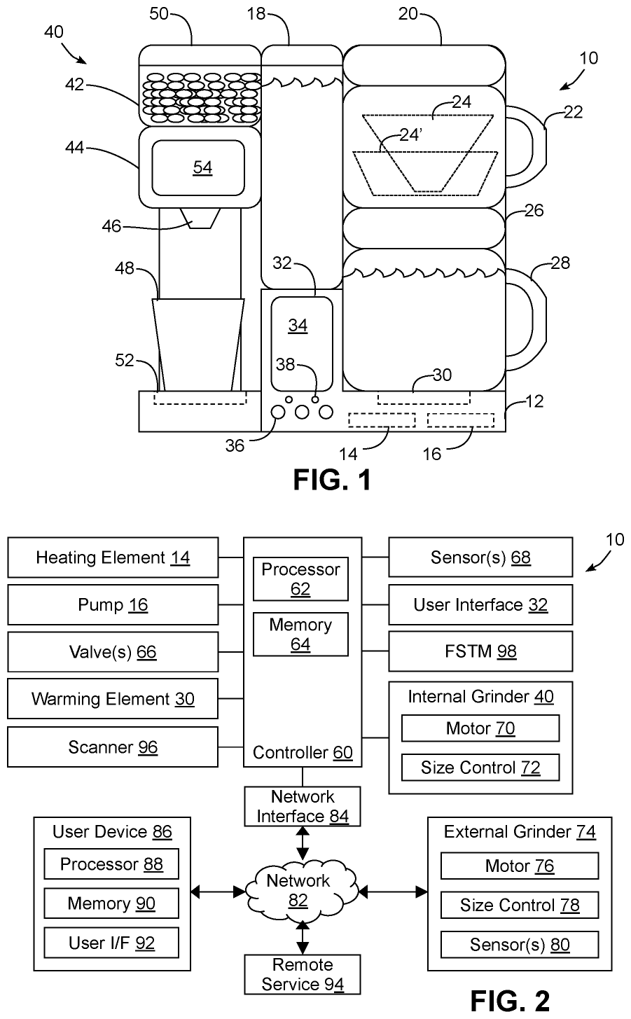

Now turning to the drawings, wherein like parts are denoted by like numbers throughout the several views, FIG. 1 illustrates a drip coffee maker 10 consistent with some embodiments of the invention. Drip coffee maker 10 may include a base or housing 12 within which may be included various components utilized in the brewing of coffee, e.g., a heating element 14, and in some instances, a water pump 16, for heating and conveying water from a water reservoir 18 to a water dispenser 20 disposed above a brew basket 22 within which may be disposed a quantity of ground coffee, and in many instances, a disposable or reusable filter.

Brew basket 22 in some embodiments may be removable and/or may incorporate a lid or cover providing access to the brew basket 22 when adding ground coffee and a filter prior to brewing and/or when removing the ground coffee and filter after brewing. In some embodiments, a filter support 24 may be used to support a filter, and the coffee grounds contained therein, during a drip coffee brewing operation, and as will become more apparent below, filter support 24 may transformable into a plurality of configurations to support different sizes and/or configurations of coffee filters and/or to support different types of coffee brewing operations (e.g., as represented at 24′). Water dispenser 20 in some embodiments may include a shower head or other suitable mechanism for dispensing heated water evenly across the top surface of the ground coffee disposed in brew basket 22 during brewing.

Disposed beneath brew basket 22 is a coffee dispenser 26 that collects the brewed coffee that passes through the filter in brew basket 22 to dispense the brewed coffee into a container via gravity feed, e.g., a carafe 28, which is some instances may be a glass carafe or a thermal carafe, although brewing may be permitted into other types of containers, e.g., mugs or cups. Coffee dispenser 26 may, in some instances, also include an automatic shut-off valve that shuts off dispensing during a brewing operation if the carafe is removed by a consumer. In some instances, a warming element 30 may also be provided in order to maintain a desirable coffee temperature after brewing.

A user interface 32, e.g., including a graphical and/or touchscreen display 34, one or more physical controls 36 (e.g., buttons, knobs, sliders, etc.) and/or one or more indicators 38 (e.g., lights, alphanumeric displays, etc.), may also be disposed on base 12 to enable a user to interact with the drip coffee maker 10.

In some embodiments, a coffee grinder 40 may also be integrated with and/or interfaced with drip coffee maker 10. Coffee grinder 40, for example, may be integrally disposed in base or housing 12 in some embodiments, while in other embodiments, coffee grinder 40 may be removably coupled to or positionable proximate base or housing 12 and interfaced through one or more wires, one or more contacts, or a wireless network to enable commands and/or data to be communicated therebetween. Coffee grinder 40 may also be powered by drip coffee maker 10 or may be separately powered in various embodiments. In still other embodiments, no coffee grinder may be used, or to the extent a consumer grinds coffee for use with drip coffee maker 10, he or she does so using a completely separate coffee grinder.

Coffee grinder 40 may include a bin or hopper 42 positioned over a burr or blade grinding mechanism 44 that outputs ground coffee from a chute 46 into a container 48. Bin or hopper 42 may also include a lid or cover 50 for allowing for external access to add roasted coffee beans to the bin or hopper. Grinding mechanism 44 may be configured to support variable grind sizes in some embodiments, e.g., through manual or electronically-controlled adjustments to the grinding mechanism. In addition, in some embodiments, a scale 52 may be disposed in coffee grinder 40 to measure the weight of the coffee dispensed through chute 46. User interaction with coffee grinder 40 may be provided through a dedicated interface 54 in some embodiments, while in other embodiments, user interface 32 of drip coffee maker 10 may also control coffee grinder 40.

With further reference to FIG. 2, drip coffee maker 10 may be under the control of a controller 60 that receives inputs from a number of components and drives a number of components in response thereto. Controller 60 may, for example, include one or more processors 62 and a memory 64 within which may be stored program code or instructions for execution by the one or more processors 62. The memory may be embedded in controller 60, but may also be considered to include volatile and/or non-volatile memories, cache memories, flash memories, programmable read-only memories, read-only memories, etc., as well as memory storage physically located elsewhere from controller 60, e.g., in a mass storage device or on a remote computer interfaced with controller 60. Controller 60 may also be implemented as a microcontroller in some embodiments, and as such these terms are used interchangeably herein. Controller 60 may also include discrete circuit logic in some embodiments, e.g., including passive and/or active circuit components.

As shown in FIG. 2, controller 60 may be interfaced with various components, including the aforementioned heating element 14, pump 16, warming element 30, user interface 32, and coffee grinder 40, as well as one or more electronically-controlled valves 66 and one or more sensors 68.

In some embodiments, for example, electronically-controlled valves 66 may be disposed upstream and/or downstream of brew basket 22 to effectively control the amount of time that water contacts the ground coffee in the brew basket. An upstream valve 66, for example, may be used to control the flow of heated water into the brew basket 22. A downstream valve 66 may be used to control the flow of coffee out of brew basket 22 into carafe 28 or another container, and in some embodiments, such a valve may also be fully closeable to prevent coffee from dripping from the brew basket whenever carafe 28 is removed. A downstream valve 66 may also, in some embodiments, enable alternate types of brewing processes, e.g., cold brewing processes where unheated water is steeped in coffee grounds for a relatively long duration. While in some embodiments upstream and/or downstream valves 66 may be used, in other embodiments, no electronically-controllable valves may be used and/or one or both of valves 66 may be mechanically controlled or may be omitted entirely. For the purposes of this disclosure, each of pump 16 and valves 66 may be considered to be a flow control device insofar as each may be used in the control of water flow through the brew basket (i.e., either into the brew basket, out of the brew basket, or both).

A wide variety of different types of sensors 68 may also be used, including for example, temperature sensors, fluid pressure sensors, fluid level sensors, flowmeters, presence sensors (e.g., to detect the proper positioning of a carafe, a brew basket, a water reservoir, a grinder hopper, etc.), position sensors, weight sensors, etc. Other sensors that may be suitable in monitoring the status of and otherwise controlling the operation of drip coffee maker 10 will be appreciated by those of ordinary skill having the benefit of the instant disclosure.

As noted above, where coffee grinder 40 is implemented as an internal coffee grinder, controller 60 may be configured to control various components of the coffee grinder directly, e.g., a motor 70 that drives the grinding process (e.g., by rotating one burr cutting element relative to another burr cutting element), and where electronic control of grind size is supported, a size control 72. Size control in other embodiments may be a manual adjustment.

Alternatively, where drip coffee maker 10 is interfaced with an external coffee grinder (e.g., external coffee grinder 74 of FIG. 2, shown including a motor 76, optional size control 78, and one or more sensors 80), controller 60 may communicate with the external coffee grinder over a network 82 through a network interface 84 to instruct the external coffee grinder to grind coffee, e.g., to grind a desired amount (e.g., based on weight or duration) and/or to grind at a specified grind size.

Network interface 84, for example, may represent one or more network interfaces suitable for interfacing with external devices via wired and/or wireless networks such as Ethernet, Bluetooth, NFC, cellular and other suitable networks. It may also be desirable, for example, to interface with one or more user devices 86, e.g., a consumer's mobile phone, which may include one or more processors 88, a memory 90 and a user interface 92) to enable a customer to control drip coffee maker 10 through the user device 86. It may also be desirable to interface with one or more remote services 94, e.g., to obtain firmware updates, to access remote databases with recipes, coffee bean information, to persist user preferences, to provide maintenance or diagnostic functionality, etc. Moreover, in some embodiments, at least a portion of controller 60 may be implemented externally, e.g., within a mobile device, a cloud computing environment, etc., such that at least a portion of the functionality described herein is implemented within the portion of the controller that is externally implemented.

In some embodiments, controller 60 may operate under the control of an operating system and may execute or otherwise rely upon various computer software applications, components, programs, objects, modules, data structures, etc. In addition, controller 60 may also incorporate hardware logic to implement some or all of the functionality disclosed herein. Further, in some embodiments, the operational sequences performed by controller 60 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

It will be appreciated that drip coffee maker 10 may be configured in a wide variety of other manners and may omit one or more of the components discussed above and/or may incorporate other components not explicitly discussed above. For example, as illustrated in FIG. 2, it may be desirable in some embodiments to utilize a bar code or other scanner 96 to enable coffee bean or ground coffee bar codes to be scanned to identify a particular coffee bean or ground coffee being used for a coffee brewing operation and thereby enable the coffee brewing operation to be specifically tailored for a particular coffee bean or ground coffee. Such functionality could also be supported in user device 86, e.g., using a camera of the user device to capture an image of a bar code.

In addition, in some embodiments, where a transforming filter support is used, a Filter Support Transformation Mechanism (FSTM) 98 may be used and may be controlled by controller 60, as will be discussed in greater detail below.

Numerous additional variations and modifications to the drip coffee maker illustrated in FIGS. 1-2 will be apparent to one of ordinary skill in the art, as will become apparent from the description below. Therefore, the invention is not limited to the specific implementations discussed herein.

### Transformable Filter Support

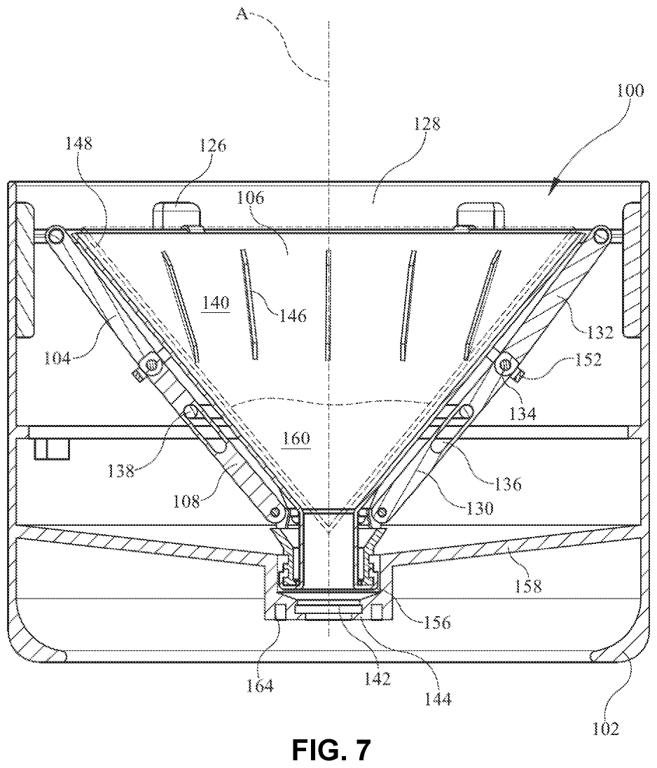

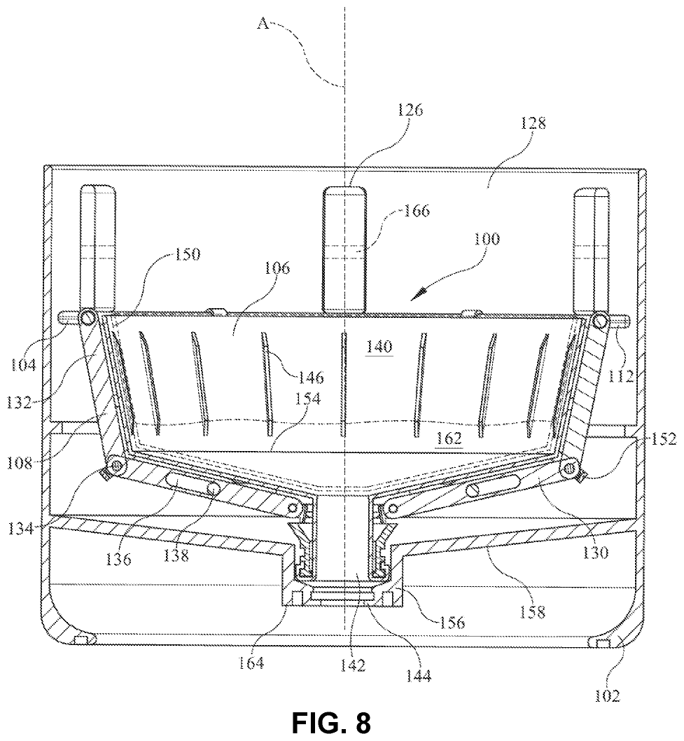

As noted above, in some embodiments, it may be desirable to utilize a transformable filter support in the brew basket of a drip coffee maker to support different sizes and/or configurations of coffee filters and/or to support different types of coffee brewing operations. A filter support, in this regard, may be considered to be a structure that is integrally formed or otherwise disposed within a brew basket, and is capable of forming at least a portion of the support structure for a disposable and/or reusable filter during a brewing operation. A transformable filter support moreover is transformable through automatic or manual operation between two or more configurations that differ from one another at least in terms of their ability to distribute and contain coffee grounds within the brew basket and thereby contribute (along with other factors, such as the amounts of ground coffee and water that are used, the grind size used to grind the coffee beans, the rate in which water enters the brew basket, and/or the rate in which coffee exits the brew basket) to the control of the water/coffee contact time during a coffee brewing operation, e.g., based upon a change in cross-sectional profile such as illustrated in FIGS. 7-8 below.

In some embodiments, the different configurations of a transformable filter support may be selected to conform to specific filter sizes and/or profiles (e.g., cone or basket filters). The different configurations may also be selected to conform to different brewing volumes of the coffee being brewed, e.g., such that one configuration is used for lower volume brewing operations and another configuration is used for greater volume brewing operations. The different configurations may also be selected to conform to different types of brewing operations (e.g., drip coffee, cold brew, tea, etc.).

Moreover, a transformable filter support is generally transformable between configurations without the need for adding or removing any components, and as such, unlike brew baskets that utilize removable inserts, a consumer is not required to store and keep track of additional drip coffee maker components when they are not in use.

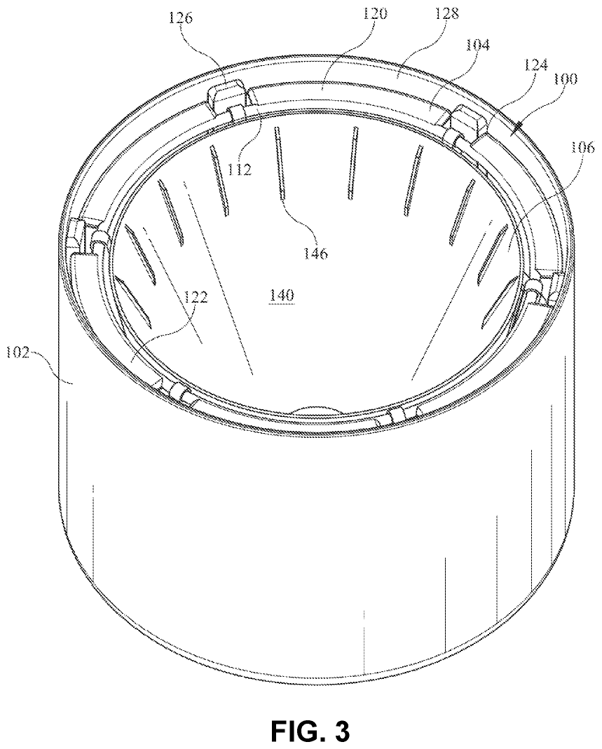

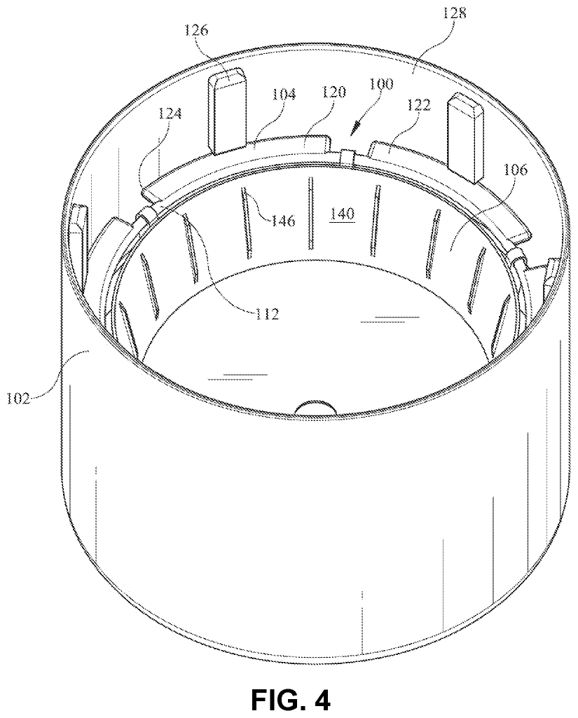

FIGS. 3-8, for example, illustrate an example transformable filter support 100 disposed in a brew basket 102, which may be utilized as an implementation, for example, of brew basket 22 of drip coffee maker 10 of FIG. 1. Transformable filter support 100 is transformable between first and second configurations, with the first configuration, suitable for supporting a narrow-profile cone filter for lower volume brewing operations, illustrated in FIGS. 3, 5 and 7, and with the second configuration, suitable for supporting a wide-profile basket filter for greater volume brewing operations, illustrated in FIGS. 4, 6, and 8.

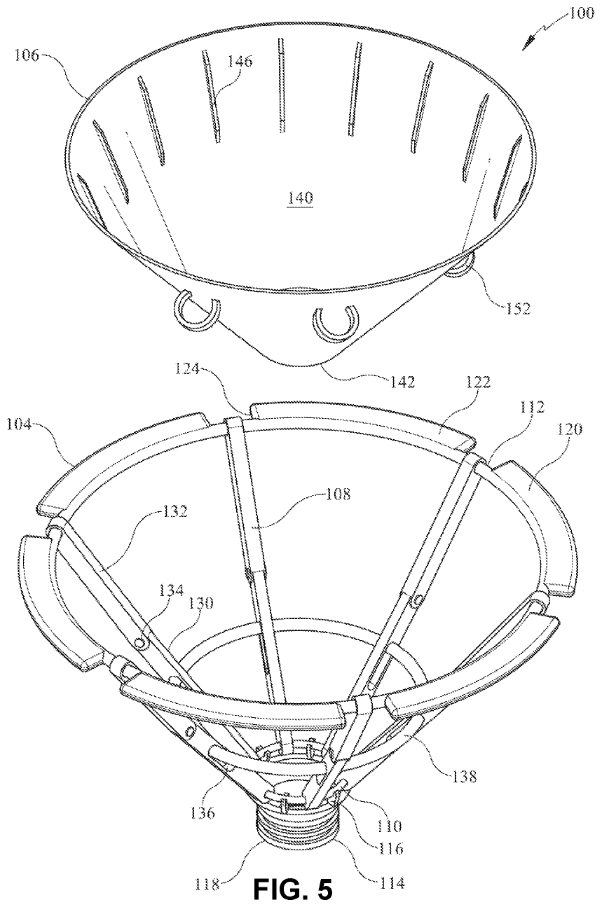

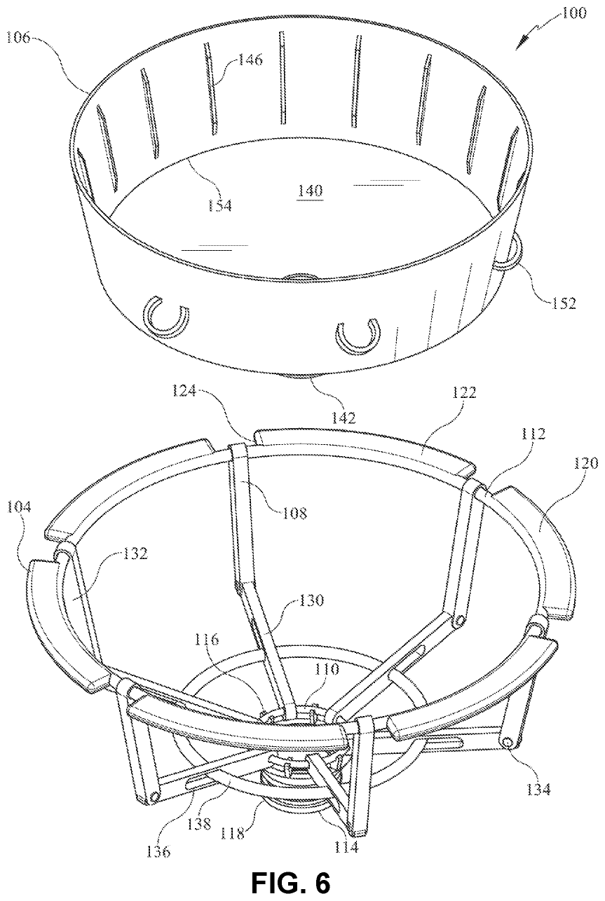

With specific reference to FIGS. 5-6, transformable filter support 100 in one implementation may include a frame 104 that supports a flexible liner 106. Frame 104 may be constructed of various materials, e.g., metal, plastic, or some combination thereof, and includes a plurality of legs 108 secured at opposing ends to a bottom member and a top member, which in this embodiment respectively implemented as bottom ring 110 and a top ring 112. Bottom ring 110 may be secured to a neck 114 having a plurality of clips 116 and forming an outlet port 118 for transformable filter support 100.

Top ring 112 includes an annular flange 120 having a widened top surface 122 interrupted by a plurality of slots 124 that are configured to align with a plurality of inwardly-projecting vertical columns 126 formed on an inner wall 128 of brew basket 10. Each leg 108 includes a pair of leg segments 130, 132 rotatably coupled to one another by a hinge 134, and the inwardly-facing surfaces of leg segments 130, 132 form the primary filter support surfaces for the transformable filter support. At the opposite end from each hinge 134, each leg segment 130 is rotatably coupled to bottom ring 110, and at the opposite end from each hinge 134, each leg segment 132 is rotatably coupled to top ring 112 proximate one of slots 124 formed in annular flange 120. Each bottom leg segment 130 also includes a longitudinal slot 136, and an alignment ring 138 extends through each longitudinal slot 136 to maintain legs 108 in alignment with one another as transformable filter support 100 transforms between the first and second configurations.

Flexible liner 106 includes at least a flexible sidewall 140, and may made of various elastic materials, e.g., silicone (among others). A neck 142 is disposed at the bottom of flexible liner 106 to serve as an outlet through which coffee is conveyed to the outlet of brew basket 102, and may include an outwardly-projecting flange 144 for securing neck 142 to neck 114 of frame 104. Sidewall 140 may also include a plurality of ribs 146 configured to separate portions of a filter (e.g., cone filter 148 illustrated in FIG. 7 or basket filter 150 illustrated in FIG. 8) from sidewall 140. Various configurations of ribs 146 may be used in different embodiments, e.g., vertical ribs, curved ribs, etc., and may be used in some embodiments to control fluid flow between the filter and the flexible liner.

In the illustrated embodiment, in addition to being secured by flange 144, flexible liner 106 is also secured to frame 104 using a plurality of loops 152 that wrap around legs 108, e.g., proximate to hinges 134. In other embodiments, other attachment arrangements may be used, e.g., via fasteners that secure tabs formed on flexible liner 106 to each leg 108 of frame 104, or in other suitable manners.

Also in the illustrated embodiment, flexible liner 106 is formed of silicone or another elastic material, and is molded in the shape illustrated in FIG. 5, such that transformable filter support 100 is biased to the first configuration of FIGS. 3, 5, and 7 when in an undisturbed state. Transformation of transformable filter support 100 to the second configuration of FIGS. 4, 6, and 8 (e.g., by pushing down on annular flange 120 to move top ring 112 of frame 104 towards bottom ring 110) therefore deforms and loads flexible liner 106 such that releasing the downward force on annular flange 120 causes flexible liner 106 to urge top ring 112 to move upwardly and away from bottom ring 110 and return transformable filter support 100 to the first configuration.

In addition, in some embodiments, a fold line 154 may also be molded into flexible liner 106 to facilitate the formation of a suitable profile for supporting basket filter 150). Furthermore, in some embodiments, flexible liner 106 may be molded and biased to the second configuration, such that transformation to the first configuration requires an upward pulling force to separate bottom and top rings 110, 112.

In the illustrated embodiment, transformable filter support 100 is rotatably supported in brew basket 102, e.g., with neck 114 of frame 104 and flange 144 of flexible liner 106 frictionally supported within a sleeve 156 formed in a bottom wall 158 of brew basket 102, slots 124 formed in annular flange 120 are aligned with columns 126 on inner wall 128 of brew basket 102, such that pushing down on annular flange 120 when transformable filter support 100 is in the first configuration illustrated in FIGS. 3 and 7 causes top ring 112 to move downward towards bottom ring 110. Once annular flange 120 has moved to a lower elevation than columns 126, transformable filter support 100 may then be rotated about a substantially vertical axis A such that slots 124 are not longer in alignment with columns 126, and columns 126 effectively engage with annular flange 120 to restrict upward movement of transformable filter support 100, thereby locking transformable filter support 100 into the second configuration illustrated in FIGS. 4 and 8. By rotating transformable filter support 100 to a rotational position that again aligns slots 124 with columns 126 and releasing downward pressure on annular flange 120 then allows top ring 112 to move upwardly and return transformable filter support 100 to the first configuration. It will be appreciated that in other embodiments, only a portion of transformable filter support 100, e.g., just annular flange 120, may be rotatable about axis A.

As shown in FIG. 7, when transformable filter support 100 is in the first configuration, the cross-sectional profile of flexible liner 106 is suitable for supporting a narrow-profile cone filter 148, such that a quantity of coffee grounds (illustrated at 160) suitable for brewing a lower volume of coffee are distributed and contained in a manner that allows for a suitable water/coffee contact time during brewing. In addition, as shown in FIG. 8, when transformable filter support 100 is in the second configuration, the cross-sectional profile of flexible liner 106 is suitable for supporting a wider-profile basket filter 150, such that a quantity of coffee grounds (illustrated at 162) suitable for brewing a greater volume of coffee are also distributed and contained in a manner that allows for a suitable water/coffee contact time during brewing. In either event, brewed coffee exits through neck 142 of flexible liner 106, and through an outlet 164 formed in a bottom of brew basket 102.

It will be appreciated that a wide variety of alternate transformable filter support designs may be used in other embodiments, e.g., designs similar to collapsible metal vegetable steamers that incorporate rotatable overlapping flaps. Moreover, in some embodiments, more than two configurations may be supported. As illustrated in FIG. 8, for example, one or more intermediate slots 166 may be formed in columns 126 in some embodiments to provide one or more intermediate positions within which annular flange 120 may be retained.

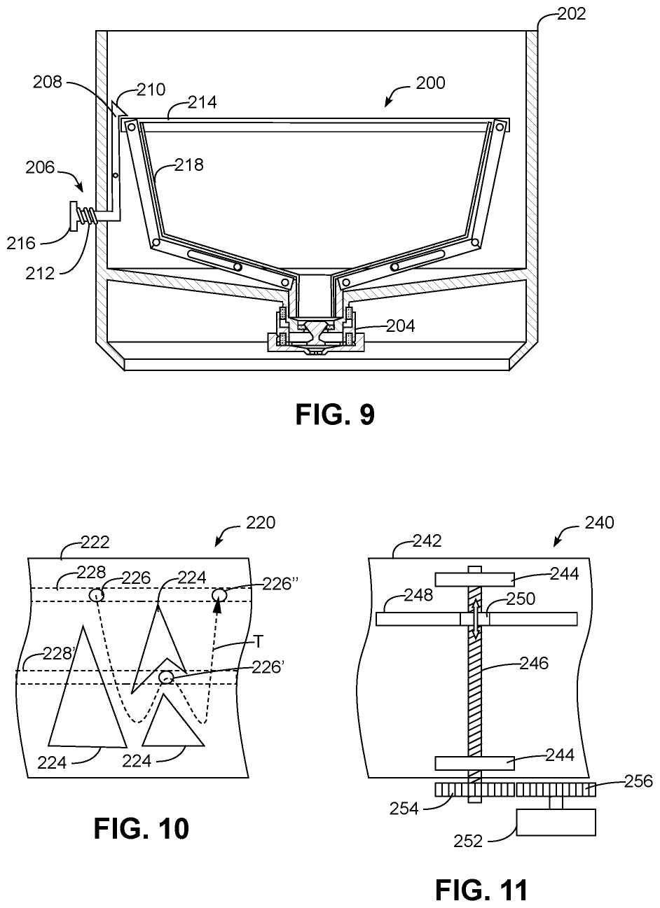

In addition, as illustrated in FIG. 9, a transformable filter support 200 similar to transformable filter support 100 may be positioned within a brew basket 202, which in this embodiment includes a valve arrangement 204 at the outlet of the brew basket similar to that of U.S. application Ser. No. 17/937,257, filed on Sep. 30, 2022 by Simon Fowler et al., which is assigned to the same assignee as the present application, and which is incorporated by reference herein. In this embodiment, a hook and release mechanism 206 is used to releasably hold transformable filter support 200 in the second configuration. A pivotable hook 208 includes an angled surface 210 and is biased by a spring 212 such that when transformable filter support 200 is pushed down from the first configuration to the second configuration, annular flange 214 of transformable filter support 200 engages angled surface 210 to deflect hook 208 and allow movement to the second configuration. Spring 212 then returns hook 208 to the position illustrated in FIG. 9 to catch annular flange 212 and maintain transformable filter support 200 in the second configuration. When it is desirable to return transformable filter support 200 to the first configuration, a button 216 may then be depressed to retract hook 208 and allow the bias of flexible liner 218 to move the annular flange 212 upwardly back to the first configuration.

FIG. 10 illustrates a portion of a press release loop mechanism 220 that may be used in another embodiment to transform a transformable filter support between different configurations. Mechanism 220 may be configured similar to a retractable pen mechanism, e.g., where pressing down on a transformable filter support when in a first configuration locks the transformable filter support into a second configuration, and vice versa. Put another way, the press release loop mechanism 200 toggles the transformable filter support between the first and second configurations when pressed. FIG. 10 illustrates an inner-facing portion of a brew basket sidewall 222, with press release loop mechanism 220 including a plurality of projections 224 arranged on sidewall 222 such that a pin 226 coupled to an annular flange 228 of a transformable filter support follows a track T. When annular flange 228 is pushed down from a first (extended) configuration of the transformable filter support, the arrangement of projections 224 causes pin 226 to be retained in the position illustrated at 226′, and with annular flange 228 held in the position illustrated at 228′, thus transforming the transformable filter support into a second (compressed) configuration. Pressing down on annular flange 228 a second time then releases pin 226 and allows both pin 226 and annular flange 228 to return to their initial configurations, but with the transformable filter support having rotated to where pin is now in the position illustrated at 226″. It will be appreciated that projections 224 may be formed in a repeating pattern for the entire circumference of sidewall 222 such that track T defines a loop.

FIG. 11 illustrates an automatic lift mechanism 240 that may be used in another embodiment to transform a transformable filter support between different configurations, including two or more discrete configurations, or even a continuous range of configurations in some embodiments. A portion of a brew basket 222 is illustrated, with a plurality of mounts 244 rotatably supporting a threaded lead screw 246 of automatic lift mechanism 240. An annular flange 248 of a transformable filter support includes a threaded nut 250 that threadably engages lead screw 246 such that rotation of lead screw 246 drives nut 250, and thus annular flange 248, substantially vertically. An electronically-controllable drive, e.g., motor 252, is operably coupled to lead screw 246 through a gear arrangement including gears 254, 256, although it will be appreciated that in other embodiments, other gear arrangements, or even a direct drive, may be used. It will also be appreciated that an encoder or one or more position switches may be used to provide feedback as to the current position of annular flange 248 in some embodiments.

With an automatic lift mechanism 240, a drip coffee maker controller (e.g., controller 60 of FIG. 2) may be capable of automatically configuring a drip coffee maker based upon user configuration of a coffee brewing operation. For example, selection of a lower brewing volume (e.g., 1-6 cups) by a user may cause a controller to activate automatic lift mechanism 240 to move the transformable filter support to a first configuration suitable for supporting a narrow-profile cone filter, while selection of a greater brewing volume (e.g., 7-14 cups) by a user may cause the controller to activate automatic lift mechanism 240 to move the transformable filter support to a second configuration suitable for supporting a wide-profile basket filter when brewing a full pot and/or greater volume of coffee. As a result of such a selection, a user may also be notified on a display, for example, as to the correct filter to use for the brewing volume selected by the user.

It will be appreciated that the various mechanisms described herein for transforming a transformable filter support between different configurations are among an innumerable number of possible mechanisms. As such, the invention is not limited to the particular mechanisms described herein.

It will also be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. A drip coffee maker, comprising:
a brew basket configured to house coffee grounds during brewing, the brew basket including an outlet proximate a bottom thereof through which coffee is dispensed;
a water dispenser disposed upstream of the brew basket and configured to supply heated water to the brew basket to bring the heated water into contact with the coffee grounds to perform a drip coffee brewing operation; and
a transformable filter support disposed in the brew basket to support a filter, the transformable filter support configured to transform between a plurality of different configurations for use with different coffee brewing operations.

2. The drip coffee maker of claim 1, wherein the plurality of different configurations different from one another based on cross-sectional profile.

3. The drip coffee maker of claim 1, wherein the plurality of different configurations different from one another based on brewing operation type.

4. The drip coffee maker of claim 1, wherein the plurality of different configurations different from one another based on brewing volume.

5. The drip coffee maker of claim 1, wherein the plurality of different configurations different from one another based on size and/or shape of filter supported by the transformable filter support.

6. The drip coffee maker of claim 5, wherein the plurality of different configurations include a first configuration configured to support a narrow-profile cone filter and a second configuration configured to support a wide-profile basket filter.

7. The drip coffee maker of claim 1, wherein the transformable filter support includes a frame, the frame including:
a top member;
a bottom member; and
a plurality of hinged legs, each hinged leg secured to and extending between the top and bottom members and including inwardly-facing surfaces configured to support the filter in the transformable filter support.

8. The drip coffee maker of claim 7, wherein each hinged leg includes first and second leg segments rotatably coupled to one another through a hinge, the first leg segment rotatably coupled to the top member and the second leg segment rotatably coupled to the bottom member.

9. The drip coffee maker of claim 8, wherein each hinged leg further includes a longitudinal slot, and the transformable filter support further includes an alignment ring extending through the longitudinal a lot of each hinged leg to align the plurality of legs with one another.

10. The drip coffee maker of claim 9, wherein the top member includes a top ring and the bottom member includes a bottom ring, wherein the first leg segment of each leg is rotatably coupled to the top ring and the second leg segment of each leg is rotatably coupled to the bottom ring.

11. The drip coffee maker of claim 7, wherein the transformable filter support further includes a liner supported within the frame and including a flexible sidewall and an outlet configured to convey brewed coffee to the outlet of the brew basket.

12. The drip coffee maker of claim 11, wherein the liner is secured to each of the plurality of hinged legs.

13. The drip coffee maker of claim 11, wherein the liner is formed from an elastic material and is biased to a first configuration of the plurality of different configurations when in an undisturbed state such that transformation of the transformable filter support to a second configuration of the plurality of different configurations deforms and loads the liner.

14. The drip coffee maker of claim 13, wherein the first configuration is an extended configuration and the second configuration is a compressed configuration, wherein when in the extended configuration the top member is further away from the bottom member than when in the compressed configuration.

15. The drip coffee maker of claim 13, wherein the brew basket includes a plurality of inwardly-projecting vertical columns and the top member includes a plurality of slots configured to receive the plurality of inwardly-projecting vertical columns when the transformable filter support is transforming between the first and second configurations, wherein at least a portion of the top member is rotatable about a substantially vertical axis when the transformable filter support is in the second configuration to move the plurality of slots out of alignment with the plurality of inwardly-projecting vertical columns and thereby maintain the transformable filter support in the second configuration.

16. The drip coffee maker of claim 15, wherein each of the plurality of inwardly-projecting vertical columns includes an intermediate slot configured to maintain the transformable filter support in a third configuration that is intermediate the first and second configurations.

17. The drip coffee maker of claim 1, wherein the plurality of different configurations includes first and second configurations, wherein the transformable filter support is biased to the first configuration, and wherein the transformable filter support further includes a hook and release mechanism configured to releasably hold the transformable filter support in the second configuration.

18. The drip coffee maker of claim 1, wherein the plurality of different configurations includes first and second configurations, wherein the transformable filter support is biased to the first configuration, and wherein the transformable filter support further includes a press release loop mechanism configured to toggle the transformable filter support between the first and second configurations when pressed.

19. The drip coffee maker of claim 1, wherein the plurality of different configurations includes first and second configurations, and wherein the transformable filter support further includes an automatic lift mechanism including an electronically-controlled drive configured to move the transformable filter support between the first and second configurations.

20. A transformable filter support for use in a brew basket of a drip coffee maker, comprising:
a frame configured to be received in the brew basket, the frame including:
a top member;
a bottom member; and
a plurality of hinged legs, each hinged leg secured to and extending between the top and bottom members and including inwardly-facing surfaces configured to support the filter in the transformable filter support; and
a liner supported within the frame and including a flexible sidewall and an outlet configured to convey brewed coffee to an outlet of a brew basket;
wherein the top and bottom members are movable relative to one another to transform the transformable filter support between a plurality of different configurations for use with different coffee brewing operations.
